(19) United States
(12) Patent Application Publication
(10) Pub. No.: US 2014/0262833 A1
(43) Pub. Date: Sep. 18, 2014

(54) SENSOR WITH A BIFURCATED FLOWPATH

(71) Applicant: MAGELLAN DIAGNOSTICS, INC., North Billerica, MA (US)

(72) Inventors: Matthew K. Musho, York, PA (US); Mohammad Hossein Maleknia, North Andover, MA (US)

(73) Assignee: MAGELLAN DIAGNOSTICS, INC., North Billerica, MA (US)

(21) Appl. No.: 13/804,255

(22) Filed: Mar. 14, 2013

(51) Int. Cl. G01N 27/30

(52) U.S. Cl. CPC G01N 27/30
USPC 205/782; 204/400; 204/412; 204/403.01; 205/775

(57) ABSTRACT

A sensor having a bifurcated flow path and method for using the same is disclosed. In some embodiments, the sensor has two flow channels into which sample flow is induced by capillary action, wherein the flow channels are in contact with electrodes configured to generate an electrochemical reaction in the flow channels which can be measured and correlated to the level of an analyte in the sample. In some embodiments, the levels of more than one analyte can be measured using a single sensor.

### BACKGROUND OF THE INVENTION

1. Field

This disclosure relates to a sensor for detecting and measuring two analytes in a liquid sample.

2. Description of the Related Art

It is frequently desired to analyze the amount of an analyte in a liquid sample. Of particular interest is measuring analyte concentrations in a sample of blood, including vertebrate, mammalian or human blood using an electrochemical sensor. When sampling analytes in blood, it may be desirable to sample for more than one analyte. This may require using a separate sensor, reagent, and/or sampling apparatus for each analyte. Using a separate sensor, reagent, and/or sampling apparatus may be time consuming and costly. Therefore, a sensor which can detect and/or measure the concentration of two analytes in a single sampling operation is desired.

### SUMMARY

In one aspect described herein, a sensor for electrochemically measuring at least two analytes in a liquid sample comprises a substrate having a reservoir configured to receive the liquid sample; a first channel in fluid communication with the reservoir, the channel extending away from the reservoir in a first direction; a second channel in fluid communication with the reservoir, the channel extending away from the reservoir in a second direction; a lid attached to the top of the substrate having a hole formed therein, through which the liquid sample can be introduced to the reservoir, a first aperture disposed proximate the first fluid channel and a second aperture disposed proximate to the second fluid channel; and first and second electrochemical sensors for measuring the first and second analytes, respectively.

In some embodiments, the substrate further comprises a plurality of electrodes.

In some embodiments, the plurality of electrodes comprises a first electrode in electrical contact with the first channel, a second electrode in electrical contact with the second channel, and at least one reference electrode.

In some embodiments, the at least one reference electrode comprises a first reference electrode corresponding to the first electrode and a second reference electrode corresponding to the second electrode.

In some embodiments, the first aperture is disposed in the lid at a position above the first channel.

In some embodiments, the second aperture is disposed in the lid at a position above the second channel.

In some embodiments, the first aperture is disposed in the lid at a position above the first channel such that the first aperture enables fluid to flow from the reservoir into the first channel.

In some embodiments, the second aperture is disposed in the lid at a position above the second channel such that the second aperture enables fluid to flow from the reservoir into the second channel.

In some embodiments, one of the at least two analytes is lead and another of the at least two analytes is hemoglobin.

In another aspect, a sensor having a bifurcated sample path for measuring at least two analytes in a liquid sample comprises a substrate; a reservoir on the substrate configured to receive the liquid sample; a first channel on the substrate in fluid communication with the reservoir, the first channel having a first end and a second end, wherein the first end of the first channel is proximal to the reservoir and the second end of the first channel is distal to the reservoir; a second channel on the substrate in fluid communication with the reservoir, the second fluidic channel having a first end and a second end, wherein the second channel extends in a direction other than that of the first channel, and wherein the first end of the second channel is proximal to the reservoir and the second end of the second channel is distal to the reservoir; a lid connected to the substrate, the lid comprising: a sample hole formed in the lid, the hole being disposed above the reservoir, wherein the sample hole is configured to provide sample access to the reservoir; a first air aperture formed in the lid at a position substantially above to the second end of the first channel, the first air aperture being configured to enable flow of the liquid sample from the reservoir to the second end of the first channel; a second air aperture formed in the lid at a position substantially above the second end of the second channel, the second air aperture being configured to enable flow of the liquid sample from the reservoir to the second end of the second channel; a first electrode in the substrate in electrical contact with the first channel configured to enable a first electrochemical reaction with the liquid sample present in the first channel to detect a first analyte; and a second electrode in the substrate in electrical contact with the second fluidic channel configured to enable a second electrochemical reaction with the liquid sample present in the second channel to detect a different, second analyte.

In some embodiments, the method further comprises a first reference electrode and a second reference electrode.

In some embodiments, the first channel and the second fluid channel extend in directions substantially opposite to each other.

In some embodiments, the first air aperture and the second air aperture are disposed 180° apart from each other.

In some embodiments, the liquid sample is capable of simultaneously flowing from the reservoir in both the first and second fluid channels.

In some embodiments, one of the at least two analytes is lead and another of the at least two analytes is hemoglobin.

In another aspect, a method of measuring at least two analytes in a liquid sample comprises introducing a sample into a reservoir of a sensor, wherein the sensor comprises: a first channel in fluid communication with the reservoir and a second fluid channel in communication with the reservoir; a lid comprising a sample hole configured to provide access to the reservoir, the lid further comprising a first air aperture proximate the first channel and a second air aperture proximate the second channel; a first electrode in electrical contact with the first channel and a second electrode in contact with the second channel; flowing the liquid sample from the reservoir into the first channel and the second channel; initiating an electrochemical reaction within the liquid sample in the first channel and the second channel; electrochemically measuring the levels of one of the at least two analytes in the first channel; and electrochemically measuring the level of another of the at least two analytes in the second channel.

The method of claim 16, wherein the sensor further comprises a first reference electrode corresponding to the first electrode and a second reference electrode corresponding to the second electrode.

In some embodiments, the method further comprises adding a reagent to the reservoir and flowing the reagent into the first and second channels.

In some embodiments, initiating the electrochemical reaction comprises applying a voltage to the first and second reference electrodes.

In some embodiments, initiating the electrochemical reaction induces a current at the first electrode and the second electrode.

In some embodiments, measuring the levels of one of the at least two analytes comprises detecting the current induced on the first electrode and correlating the current at the first electrode to a concentration of the one of the at least two analytes, and wherein measuring the level of another of the at least two analytes comprises detecting the current induced at the second electrode and correlating the current at the second electrode to a concentration of the another of the at least two analytes.

In some embodiments, measuring one of the at least two analytes comprises measuring lead and wherein measuring another of the at least two analytes comprises measuring hemoglobin.

In some embodiments, the liquid sample is a mammalian blood sample.

### BRIEF DESCRIPTION OF THE DRAWINGS

FIG. 1 depicts the layers comprising a sensor configured to sample two analytes.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Disclosed in the present application are a sensor, system, and methods for analyzing a sample for two or more analytes. In some embodiments, the sample is a vertebrate or mammalian blood sample, and the sample is placed on an electrochemical sensor of the present disclosure, the sensor being readable using an analyzer, which may be a multiple channel analyzer. In some embodiments, the blood sample is analyzed for blood lead concentration and another analyte, such as hemoglobin, using a single sensor. A sensor having a substrate suitable for use in sampling blood lead levels is described in U.S. Pat. No. 5,468,366, the entire contents of which are herein incorporated by reference. Blood lead concentration analysis is described in U.S. Pat. No. 5,879,990, the entire contents of which are herein incorporated by reference.

As used herein, the terms “simultaneously,” or “at the same time” need not necessarily mean at exactly the same moment, and may mean that two actions or operations occur concurrently. For example, in the following disclosure, reference is made to analyzing two or more analytes at the same time or simultaneously. This need not mean that the sensors or sampling apparatus are performing the analysis at exactly the same moment, or that electrical signals are applied to the sensing electrodes of the sensor at exactly the same moment. In some embodiments, an interrupt service request apportions processor time to the various components of the analyzer, and, thus, the individual sensor electrodes, and may not actually send signals to multiple electrodes at the same time. However, due to the speed of the processor and the operations, the analysis or operations are effectively simultaneous, or, at least, appear to be simultaneous to the user. Similarly, where reference is made to operations on sensors occurring at the same time, this may mean that the operations occur at effectively the same time, or appear to occur at the same time, when in fact, the operations are sequenced within the processor, and do not occur at exactly the same time.

FIG. 1 depicts an embodiment of an electrochemical sensor configured to receive a sample and facilitate analysis of two analytes in the sample. The sensor 100 comprises multiple layers: a contact layer 110, a first carbon layer 120, a second carbon layer 130, a dielectric layer 140, a spacer layer 150, and a top layer 160. Layers 110-160 are depicted individually for convenience and ease of description. Also, the sensor 100, the layers 110-160 are depicted as being disposed on each other in increasing numerical order, to form the complete sensor.

The contact layer 110 comprises contacts and electrical traces attached thereto. In some embodiments, the contacts and traces may be a silver-containing material silk screened onto a substrate 118. In some embodiments, the contacts and electrical traces may be printed, etched, or otherwise deposited on the substrate 118. In some embodiments, other conductive materials may be used, as desired.

In some embodiments, the sensor comprises five contacts: a first reference electrode contact 111, a second test electrode contact 112, an auxiliary or counter electrode contact 113, a second reference electrode contact 114, and a first test electrode contact 115. The contacts 115 are disposed on a first end 116 of the substrate 118 of the contact layer 110, and are exposed such that upon insertion of the sensor 100 into a sensor analyzer (not shown), the contacts 110-115 can make electrical contact with corresponding contacts in the analyzer to facilitate analysis of the sample. An example of an analyzers for analyzing sensors similar to those provided here can be found in U.S. patent application Ser. No. 13/790,154, filed Mar. 8, 2013, the entire contents of which are incorporated herein by reference.

Each of contacts 111-115 is in electrical connection with an electric or conductive trace, extending generally away from the first end 116 of the substrate 118 and toward the second end 117 of the substrate 118. The second reference electrode contact 114 is in electrical contact with a second reference electrode 124. The other electric traces terminate at points on the substrate 118 which correspond to electrodes disposed on the first carbon layer 120, which will be described below. Although one configuration is depicted for the electric traces and the contacts, one of skill in the art will understand that a different contact order or trace configuration can be used without departing from the scope of the present application.

The first carbon layer 120 is disposed on the contact layer 110. In some embodiments, the carbon layer 120 is sprayed, sputtered, printed, or otherwise deposited onto the contact layer. The carbon of the carbon layer may be a glassy carbon, and may cover a substantial portion of the contact layer 110. In some embodiments, the carbon layer 120 may only be deposited onto the areas of the substrate which will contain the electrodes which will be described below, leaving much of the substrate uncovered by the carbon layer. The carbon layer 120 comprises a first reference electrode 121, a second test electrode 122, a counter electrode 123, and a first test electrode 125. The electrodes of the carbon layer 120 may advantageously comprise a colloidal gold solution sputtered, printed, sprayed, air brushed, or otherwise deposited on the carbon layer 120. Each of electrodes 121, 122, 123, and 125 are disposed on the carbon layer so as to be in electrical communication with the corresponding electrode traces and contacts 111, 112, 113, and 115. The first carbon layer 120 may also comprise contacts 111a, 112a, 113a, 114a, and 115a, which are disposed to be above and in electrical communication with corresponding contacts 111, 112, 113, 114, and 115 of the contact layer. The contacts 111a-115a may be configured to be in electrical communication with the analyzer together with corresponding contacts 111-115 when the sensor is inserted into a sample analyzer.

The second carbon layer 130 is disposed on the first carbon layer 120, and may be sprayed, sputtered, brushed, or otherwise deposited on the first carbon layer 120. The second carbon layer may comprise a carbon region 135. The carbon region 135 may be a small region of carbon deposited onto the area above the second test electrode. In some embodiments, the carbon region 135 may completely cover the second test electrode 122. In some embodiments, the carbon region 135 may cover only a portion the second test electrode 122. The carbon region 135 is disposed in the second carbon layer at a point generally between the first end 116 and the second end 117, and is located above the second test electrode 123. The carbon region 135 may be circular, rectangular, trapezoidal, square, triangular, polygonal, or any other desired shape. In some embodiments, the carbon region 135 supplies an additional layer of carbon ink to provide a sufficient ink thickness in the carbon region 135 to achieve acceptable sensor performance.

The dielectric layer 140 is disposed on the second carbon layer 130. The dielectric layer may comprise an electrically insulating material and may be made of a polymeric material. The dielectric layer 140 may serve to protect and isolate the active surfaces of the contact layer 110 and the first carbon layer 120. The dielectric layer 140 is formed having a counter electrode void 141, a sample void 142, and an electrode void 145. The counter electrode void 141 is disposed within the dielectric layer so that the counter electrode void is above the counter electrode 123, and may be circular, rectangular, trapezoidal, square, triangular, polygonal, or any other desired shape. The sample void 142 is disposed within the dielectric layer 140 so as to be above at least the second reference electrode 124, the first reference electrode 121 and the first test electrode 125. The sample void 142 may have a wide portion and an elongate narrower portion. The elongate narrower portion is disposed so as to be above the first reference electrode 121 and the first test electrode 125. The wide portion acts as part of the sample reservoir which will be described below. The dielectric layer may not extend to completely cover the entirety of the substrate 118 below. For example, the dielectric layer may not extend to completely to the first end 116 or the second end 117, thereby leaving the contacts 111-115 and 111a-115a available to make electrical connections in a sample analyzer.

The spacer layer 150 is disposed on the dielectric layer. The dielectric layer is formed with a spacer void 155 disposed therein. The spacer may comprise an electrically insulating material, such as Mylar®, and may have an adhesive on a bottom and top surface thereof to adhere the spacer layer 150 to the dielectric layer 140 below and the top layer 160 above. The spacer void may be an elongate void extending from the center of the spacer layer 150 toward both the first end 116 and the second end 117 of the substrate 118. The spacer void 155 may be a single, continuous void, disposed within the spacer layer 150 so as to be above the counter electrode void 141, the sample void 142 and the electrode void 145. The spacer void 155 defines a sample reservoir 151, a first channel 152, and a second channel 153. The sample reservoir 151 may be rounded, elongate, rectangular, or any other desired shape. In some embodiments, the sample reservoir 151 is wider than the first channel 152 and wider than the second channel 153. In some embodiments, the second channel is wider than the first channel 152. The first channel 152 extends from the sample reservoir 151 and extends to a point proximate the sample void 142 and above the first reference electrode 111 and the first test electrode 115. The second channel 153 begins at the sample reservoir 151 and extends to a point proximate to and extending beyond the counter electrode void 141, toward the first end 116 of the substrate 118 the counter electrode void 141.

The top layer 160 is disposed on the spacer layer 150, and is formed a sample void 165 and at least one aperture therein. In some embodiments, the top layer 160 the at least one aperture comprises a first vent 161 and a second vent 162. The sample void 165, is disposed above the sample reservoir 151, and allows access for a liquid sample, such as blood sample, to be placed into the sample reservoir 151. The first vent 161 is disposed at a position away from the sample void 165 proximate to and above the distal end of the first channel 152. The second vent 162 is disposed at a position away from the sample void 165, proximate to and above the distal end of the second channel 153.

The operation of the sensors will now be described with reference to FIG. 2. A liquid sample, such as a sample of blood, is placed into the sample reservoir 151 through the sample void 165. The sample flows out of the sample reservoir 151 and into the first channel 152 and the second channel 153. Under some circumstances, because of the surface tension or viscosity of the sample, the liquid sample may resist flowing into the first and second channels 152 and 153. To assist flowing of the sample, the first and second vents 161 and 162 are provided in the top layer 160. The presence of the first and second vents 161 and 162 creates capillary action, thereby causing the sample to flow from the sample reservoir 151 and into the first and second 152 and 153, all the way to the distal ends of the first and second channels 152 and 153. The capillary action ensures that sufficient sample flows to the distal ends of the first and second channels 152 and 153 and so that the analytes may be analyzed using the electrodes and contacts in the contact layer 110 and the first carbon layer 120.

In some embodiments, a first analyte is analyzed using the sample which has flowed into the first channel 152, using the first reference electrode 121 and the first test electrode 125. In some embodiments, the second analyte is analyzed using the sample which has flowed into the second channel 153, using the second test electrode 122 and the second reference electrode 124. In some embodiments, the first analyte may be lead, specifically, blood lead concentration, and the second analyte may be hemoglobin.

Following deposition of the sample in the sample reservoir 151, a reagent, buffer, pH adjusting compound, or any other desired compound maybe added to the sample reservoir 151, and may flow into the first and second channels 152 and 153 aided by capillary action induced by the first and second vents 161 and 162.

With the sensor 100 inserted into a sample analyzer, the analyzer is in electrical contact with the contacts 111-115. The sample analyzer may apply a detect a reference voltage at the first reference electrode contact 111 and the second reference electrode contact 114, which creates a reference voltage on the first reference electrode 121 and the second reference electrode 124. In some embodiments, a voltage is applied to the first reference electrode contact 111 and the second reference electrode contact 114 to maintain a constant reference voltage during the electrochemical analysis. The reference voltages or offset voltages at the first reference electrode contact 111 and the second reference electrode contact 114 may be the same, or may be different, depending on the analytes of interest to be measured using the sensor 100.

The sample in the sample reservoir 151 may come into electrical contact with the counter electrode 123 and the second reference electrode 114, or with the counter electrode 123 and the second test electrode 122 as the sample flows into the second channel 152. When the sample creates a conductive connection between the second reference electrode 124 and the counter electrode 123, the connection may be detected in the sample analyzer via the counter electrode 123, and may be a signal to the analyzer to commence analysis. Furthermore, an offset voltage may be applied to the counter electrode 123 during electrochemical analysis to minimize or prevent current flow in the second reference electrode 124. In some embodiments, a similar counter electrode design may be used to prevent current flow in the first reference electrode.

With the sample in the first channel 152, the sample creates an electrical connection between the first reference electrode 121 and the first test electrode 125. Upon the application of a reference voltage to the first reference electrode 121, an electrochemical reaction may occur in the first channel 152, and a current may be generated on the first test electrode 125 which is based on or is proportional to the concentration or amount of analyte in the sample. The analyzer may detect the current generated at on the first test electrode 125 which flows along an electrical trace and to the first test electrode contact 115, and into the analyzer where it is detected and measured.

Similarly, with the sample in the second channel 153, the sample creates an electrical connection between the second reference electrode 114 and the second test electrode 122. Upon application of a reference voltage from the analyzer to the second reference electrode 114, an electrochemical reaction may occur in the second channel 153, and a current may be generated at the second test electrode 122, which flows along an electrical trace to the second test electrode contact 125, where it is detected and measured by the analyzer.

The analyzer is configured to interpret the amount of current or voltage detected at the first and second test electrode contacts 115 and 112, and correlate the current with a concentration or amount of an analyte. A person of skill in the art will understand that various methods of supplying reference voltages, measuring and interpreting the resultant currents may be used without departing from the scope of the current application.

The embodiments presented above are exemplary only, and a person of skill in the art will understand that variations to the above described embodiments may be made without departing from the scope of the present application.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A sensor for electrochemically measuring at least two analytes in a liquid sample comprising:
a substrate having a reservoir configured to receive the liquid sample;
a first channel in fluid communication with the reservoir, the channel extending away from the reservoir in a first direction;
a second channel in fluid communication with the reservoir, the channel extending away from the reservoir in a second direction;
a lid attached to the top of the substrate having a hole formed therein, through which the liquid sample can be introduced to the reservoir, a first aperture disposed proximate the first fluid channel and a second aperture disposed proximate to the second fluid channel; and
and first and second electrochemical sensors for measuring the first and second analytes, respectively.

2. The sensor of claim 1, wherein the substrate further comprises a plurality of electrodes.

3. The sensor of claim 2, wherein the plurality of electrodes comprises a first electrode in electrical contact with the first channel, a second electrode in electrical contact with the second channel, and at least one reference electrode.

4. The sensor of claim 3, wherein the at least one reference electrode comprises a first reference electrode corresponding to the first electrode and a second reference electrode corresponding to the second electrode.

5. The sensor of claim 1, wherein the first aperture is disposed in the lid at a position above the first channel.

6. The sensor of claim 1, wherein the second aperture is disposed in the lid at a position above the second channel.

7. The sensor of claim 5, wherein the first aperture is disposed in the lid at a position above the first channel such that the first aperture enables fluid to flow from the reservoir into the first channel.

8. The sensor of claim 6, wherein the second aperture is disposed in the lid at a position above the second channel such that the second aperture enables fluid to flow from the reservoir into the second channel.

9. The sensor of claim 1, wherein one of the at least two analytes is lead and another of the at least two analytes is hemoglobin.

10. A sensor having a bifurcated sample path for measuring at least two analytes in a liquid sample comprising:
a substrate;
a reservoir on the substrate configured to receive the liquid sample;
a first channel on the substrate in fluid communication with the reservoir, the first channel having a first end and a second end, wherein the first end of the first channel is proximal to the reservoir and the second end of the first channel is distal to the reservoir;
a second channel on the substrate in fluid communication with the reservoir, the second fluidic channel having a first end and a second end, wherein the second channel extends in a direction other than that of the first channel, and wherein the first end of the second channel is proximal to the reservoir and the second end of the second channel is distal to the reservoir;
a lid connected to the substrate, the lid comprising:
a sample hole formed in the lid, the hole being disposed above the reservoir, wherein the sample hole is configured to provide sample access to the reservoir;
a first air aperture formed in the lid at a position substantially above to the second end of the first channel, the first air aperture being configured to enable flow of the liquid sample from the reservoir to the second end of the first channel;
a second air aperture formed in the lid at a position substantially above the second end of the second channel, the second air aperture being configured to enable flow of the liquid sample from the reservoir to the second end of the second channel;
a first electrode in the substrate in electrical contact with the first channel configured to enable a first electrochemical reaction with the liquid sample present in the first channel to detect a first analyte; and
a second electrode in the substrate in electrical contact with the second fluidic channel configured to enable a second electrochemical reaction with the liquid sample present in the second channel to detect a different, second analyte.

11. The sensor of claim 10, further comprising a first reference electrode and a second reference electrode.

12. The sensor of claim 10, wherein the first channel and the second fluid channel extend in directions substantially opposite to each other.

13. The sensor of claim 12, wherein the first air aperture and the second air aperture are disposed 180° apart from each other.

14. The sensor of claim 10, wherein the liquid sample is capable of simultaneously flowing from the reservoir in both the first and second fluid channels.

15. The sensor of claim 10, wherein one of the at least two analytes is lead and another of the at least two analytes is hemoglobin.

16. A method of measuring at least two analytes in a liquid sample comprising:
introducing a sample into a reservoir of a sensor, wherein the sensor comprises:
a first channel in fluid communication with the reservoir and a second fluid channel in communication with the reservoir;
a lid comprising a sample hole configured to provide access to the reservoir, the lid further comprising a first air aperture proximate the first channel and a second air aperture proximate the second channel;
a first electrode in electrical contact with the first channel and a second electrode in contact with the second channel;
flowing the liquid sample from the reservoir into the first channel and the second channel;
initiating an electrochemical reaction within the liquid sample in the first channel and the second channel;
electrochemically measuring the levels of one of the at least two analytes in the first channel; and
electrochemically measuring the level of another of the at least two analytes in the second channel.

17. The method of claim 16, wherein the sensor further comprises a first reference electrode corresponding to the first electrode and a second reference electrode corresponding to the second electrode.

18. The method of claim 16 further comprising adding a reagent to the reservoir and flowing the reagent into the first and second channels.

19. The method of claim 17, wherein initiating the electrochemical reaction comprises applying a voltage to the first and second reference electrodes.

20. The method of claim 19, wherein initiating the electrochemical reaction induces a current at the first electrode and the second electrode.

21. The method of claim 20, wherein measuring the levels of one of the at least two analytes comprises detecting the current induced on the first electrode and correlating the current at the first electrode to a concentration of the one of the at least two analytes, and wherein measuring the level of another of the at least two analytes comprises detecting the current induced at the second electrode and correlating the current at the second electrode to a concentration of the another of the at least two analytes.

22. The method of claim 16, wherein measuring one of the at least two analytes comprises measuring lead and wherein measuring another of the at least two analytes comprises measuring hemoglobin.

23. The method of claim 22, wherein the liquid sample is a mammalian blood sample.
